(19) United States
(12) Patent Application Publication
(10) Pub. No.: US 2013/0262635 A1
(43) Pub. Date: Oct. 3, 2013

(54) METHOD OF PROVIDING A BOOKMARK SERVICE AND AN ELECTRONIC DEVICE THEREFOR

(71) Applicant: SAMSUNG ELECTRONICS CO., LTD., Gyeonggi-do (KR)

(72) Inventors: Gu-Sul KIM, Seoul (KR); Min-Jung SEO, Seoul (KR); Jung-Hyun LEE, Seoul (KR); Won-Bae LIM, Seoul (KR)

(73) Assignee: SAMSUNG ELECTRONICS CO., LTD., Gyeonggi-do (KR)

(21) Appl. No.: 13/768,595

(22) Filed: Feb. 15, 2013

(30) Foreign Application Priority Data
Mar. 27, 2012 (KR) 10-2012-0030949

(51) Int. Cl. H04L 29/08

(52) U.S. Cl. CPC H04L 67/06
USPC 709/219

(57) ABSTRACT

A method for a bookmark service and an electronic device thereof include receiving multimedia contents in the electronic device, verifying channel state information of the electronic device, and setting a bookmark for the received multimedia contents based on the channel state information of the electronic device. The multimedia contents are multimedia writings such as digitized literary, music, photo, and art writings and include contents which may be stored and used in the electronic device, or a series of information contents obtained through a wireless Internet communication network or a high-speed data network.

### CLAIM OF PRIORITY

This application claims, pursuant to 35 U.S.C. § 119(a), priority to and the benefit of the earlier filing date of a Korean patent application filed in the Korean Intellectual Property Office on Mar. 27, 2012 and assigned Serial No. 10-2012-0030949, the entire disclosure of which is hereby incorporated by reference.

### BACKGROUND OF THE INVENTION

1. Field of the Invention The present invention relates to electronic bookmarks, and in particular, to a method of providing a bookmark service and an electronic device thereof

2. Description of the Related Art

As the number of users of portable electronic devices rapidly increases, service providers of the portable electronic devices provide a variety of services to secure more users. Therefore, the portable electronic device provides a variety of services such as an electronic scheduler service, an Internet search service, a Digital Multimedia Broadcasting (DMB) receiving service, a streaming service, a video reproduction service, and a game service in addition to a general phone call function.

Also, there is a growing trend toward use of multimedia contents in the portable electronic device according to development of communication technology. In some implementations in the prior art, a portable electronic device provides multimedia contents with streaming format in a network environment. When the user of the portable electronic device watches multimedia contents again after the multimedia contents are compulsorily ended by an unstable network state while he or she watches the multimedia contents in the streaming format, the user of the portable electronic device has a problem in that he or she must watch the multimedia contents from the start position of the multimedia contents, instead of at the point in the contents when the viewing of the contents was compulsorily ended.

Therefore, a portable electronic device is needed for providing a bookmark service for the user to watch the multimedia contents from an ended position of the multimedia contents after the multimedia contents are compulsorily ended.

### SUMMARY OF THE INVENTION

An aspect of the present invention is to solve at least the above-mentioned problems and/or disadvantages and to provide at least the advantages described below. Accordingly, an aspect of the present invention is to provide an apparatus and method for providing a bookmark service for multimedia contents in an electronic device.

Another aspect of the present invention is to provide an apparatus and method for setting a bookmark based on channel state information in an electronic device.

Another aspect of the present invention is to provide an apparatus and method for providing multimedia contents based on bookmark information in an electronic device.

In accordance with an aspect of the present invention, a method of providing a bookmark service in an electronic device is provided. The method includes receiving multimedia contents in the electronic device, verifying channel state information of the electronic device, and setting a bookmark based on the channel state information of the electronic device.

In accordance with another aspect of the present invention, a method of providing a bookmark service in an electronic device is provided. The method includes receiving multimedia contents in the electronic device, verifying whether a bookmark for the multimedia contents is set up, and providing multimedia contents according to the verified bookmark information.

In accordance with another aspect of the present invention, an electronic device is provided. The electronic device includes at least one processor, a memory, and at least one module, and each of the at least one module is stored in the memory and is configured to be executable by the at least one processor, wherein each of the at least one module includes at least one instruction for receiving multimedia contents in the electronic device, verifying channel state information of the electronic device, and setting a bookmark based on the channel state information of the electronic device.

In accordance with another aspect of the present invention, an electronic device is provided. The electronic device includes at least one processor, a memory, and at least one module, and each of the at least one module is stored in the memory and is configured to be executable by the at least one processor, wherein each of the at least one module include at least one instruction for receiving multimedia contents in the electronic device, verifying whether a bookmark for the multimedia contents is set up, and providing multimedia contents according to the verified bookmark information.

### BRIEF DESCRIPTION OF THE DRAWINGS

The above and other aspects, features and advantages of certain exemplary embodiments of the present invention will be more apparent from the following detailed description taken in conjunction with the accompanying drawings, in which:

FIG. 1 is a block diagram illustrating configuration of an electronic device according to one exemplary embodiment of the present invention;

FIG. 2 illustrates a process of setting a bookmark for multimedia contents based on channel state information in an electronic device according to the exemplary embodiment of the present invention;

FIG. 3 illustrates a process of setting a bookmark for multimedia contents based on channel state information in an electronic device according to an alternative exemplary embodiment of the present invention;

FIG. 4 illustrates a process of providing multimedia contents based on bookmark information in an electronic device according to the exemplary embodiments of the present invention;

FIG. 5 illustrates a process of providing multimedia contents using a bookmark list in an electronic device according to the exemplary embodiments of the present invention;

FIGS. 6A and 6B illustrate screens for providing a bookmark service for multimedia contents in an electronic device according to the exemplary embodiments of the present invention; and

FIG. 7 illustrates a screen for providing a bookmark list in an electronic device according to the exemplary embodiments of the present invention.

### DETAILED DESCRIPTION OF THE INVENTION

Hereinafter, preferred embodiments of the present invention will be described herein below with reference to the accompanying drawings. In the following description, well-known functions or constructions are not described in detail since they may obscure the present invention with unnecessary detail. The present invention may, however, be embodied in many different forms and should not be construed as limited to the exemplary embodiments set forth herein. Also, terms described herein, which are defined considering the functions of the present invention, may be implemented differently depending on user and operator's intention and practice. Therefore, the terms should be understood on the basis of the disclosure throughout the specification. The principles and features of this invention may be employed in varied and numerous embodiments without departing from the scope of the invention.

The same reference numbers are used throughout the drawings to refer to the same or like parts. Furthermore, although the drawings represent exemplary embodiments of the invention, the drawings are not necessarily to scale and certain features may be exaggerated or omitted in order to more clearly illustrate and explain the present invention.

Among the terms set forth herein, an electronic device refers to any kind of device capable of processing data which is transmitted or received to or from any external entity. The electronic device may display icons or menus on a screen to which stored data and various executable functions are assigned or mapped. The electronic device may include a computer, a notebook, a tablet PC, a mobile device, and the like.

Among the terms set forth herein, a screen refers to a display or other output devices which visually display information to the user, and which optionally are capable of receiving and electronically processing tactile inputs from a user using a stylo, a finger of the user, or other techniques for conveying a user selection from the user to the output devices.

Among terms set forth herein, data refers to any kind of information processed by the device, including text and/or images received from any external entities, messages transmitted or received, and information created when a specific function is executed by the device.

Hereinafter, a description will be given for an apparatus and method for providing a bookmark service for multimedia contents in an electronic device. Herein, the multimedia contents are multimedia writings such as digitized literary, music, photo, and art writings. The multimedia contents is defined herein as contents capable of being stored and used in an electronic device or a series of information contents provided through a wireless Internet communication network or a high-speed data network. For example, the multimedia contents include videos, webtoons, etc.

Hereinafter, the electronic device may be any one of a Personal Digital Assistant (PDA), a laptop, a smart phone, a netbook, a Mobile Internet Device (MID), a Ultra Mobile Personal Computer (UMPC), a tablet PC, a navigation device, a Moving Picture Experts Group layer 3 (MP3) player, etc.

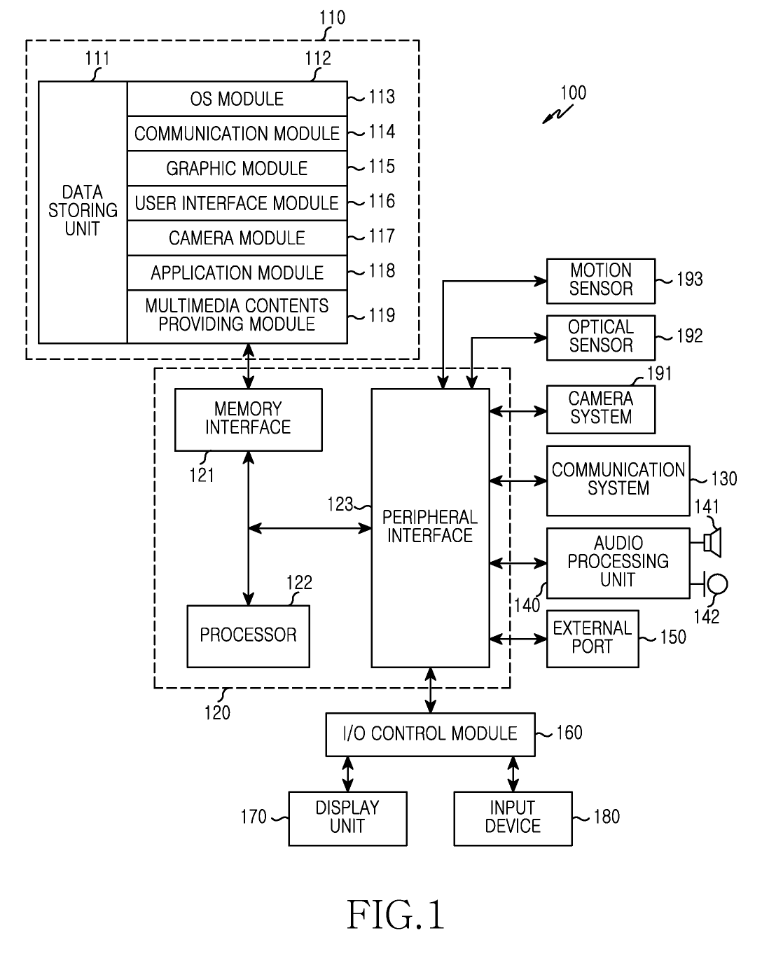

FIG. 1 is a block diagram illustrating a configuration of an electronic device according to one exemplary embodiment of the present invention.

As shown in FIG. 1, the electronic device 100 includes a memory 110, a processor unit 120, a communication system 130, an audio processing unit 140, an external port 150, an Input/Output (I/O) control module 160, a display unit 170, an input device 180, a camera system 191, an optical sensor 192, and a motion sensor 193. Herein, the memory 110, the communication system 130, and the external port 150 may be a plurality of memories, communication systems, and external ports, respectively.

A description of respective components is as follows.

The memory 110 may include a program storing unit 112 for storing a program which controls an operation of the electronic device 100 and a data storing unit 111 for storing data items generated while the program is executed. For example, the program storing unit 112 includes an Operating System (OS) module 113, a communication module 114, a graphic module 115, a user interface module 116, a camera module 117, at least one application module 118, and a multimedia contents providing module 119. The modules included in the program storing unit 112 may be expressed in a set of instructions. Also, the modules are expressed in an instruction set or programs.

The OS module 113 includes at least one software component for controlling a general system operation. Also, the OS module 113 performs at least one function for smoothly communicating between a plurality of hardware and software components.

The communication module 114 includes at least one software component for processing data items transmitted and received through the communication system 130 or the external port 150.

The graphic module 115 includes at least one software component for providing and displaying graphics on the display unit 170.

The user interface module 116 includes at least one software component related to a user interface.

The camera module 117 includes camera-related software components capable of performing camera-related processes and functions.

The application module 118 includes a software component for at least one application program installed in the electronic device 100.

The multimedia contents providing module 119 performs a control operation to set a bookmark of multimedia contents based on channel state information of a network connected to the electronic device 100. For example, if multimedia contents are received through the communication system 130, the multimedia contents providing module 119 measures a Received Signal Strength Indicator (RSSI) of the electronic device 100. If a current RSSI is lower than a reference RSSI, which may be a predetermined signal strength value, the multimedia contents providing module 119 sets a bookmark for the multimedia contents. For another example, if multimedia contents are received through the communication system 130, the multimedia contents providing module 119 measures the RSSI of the electronic device 100. If a current RSSI is lower than a first reference RSSI, the multimedia contents providing module 119 sets a bookmark for the multimedia contents. Thereafter, if a current RSSI is lower than a second reference RSSI, the multimedia contents providing module 119 may end the providing of the multimedia contents. The first and second reference RSSIs may be predetermined signal strength values.

The processor unit 120 includes a memory interface 121, at least one processor 122, and a peripheral interface 123. Herein, the memory interface 121, the at least one processor 122, and the peripheral interface 123, which are included in the processor module 120, may be integrated in at least one Integrated Circuit (IC) or may be implemented as separate components.

The memory interface 121 controls access to the memory 110 by a component such as the processor 122 or the peripheral interface 123.

The peripheral interface 123 controls connections among input and output peripherals of the electronic device 100, the processor 122, and the memory interface 121.

The processor 122 performs a control operation such that the electronic device 100 provides a variety of services such as voice communication and data communication using at least one software program. Also, the processor 122 performs a control operation such that the electronic device 100 executes at least one software module stored in the memory 110 and provides a service corresponding to an executing software module. For example, the processor 122 may include at least one of a data processor, an image processor, and an output control processor.

The communication system 130 processes signals transmitted and received through an antenna to perform data communications. Herein, the communication system 130 may be classified into a plurality of communication sub-modules which support different communication networks. For example, the communication network may be, but is not limited to, any one of a Global System for Mobile communication (GSM) network, an Enhanced Data GSM Environment (EDGE) network, a Code Division Multiple Access (CDMA) network, a W-CDMA network, a Long Term Evolution (LTE) network, an Orthogonal Frequency Division Multiple Access (OFDMA) network, a wireless Local Area Network (LAN), a BLUETOOTH network in which BLUETOOTH is a short range wireless communications technology at the 2.4 GHz band, commercially available from the BLUETOOTH SPECIAL INTEREST GROUP,

INC., a Near Field Communication (NFC) network, etc. Herein, the wireless LAN includes a tethering type network and a wireless LAN direct type network.

The audio processing unit 140 may connect to a speaker 141 and a microphone 142 and may be responsible for inputting and outputting an audio stream, such as audio signals used in a voice recognition function, a voice copy function, a digital recording function, and a phone call function.

The external port 150 includes a connection interface to connect the electronic device 100 to an external electronic device directly or to connect the electronic device 100 to another electronic device through a network. For example, the external port 150 includes a Universal Serial Bus (USB) port, a High Definition Multimedia Interface (HDMI) port, a network port complying with the IEEE 1394 interface standard, etc.

The I/O control module 160 provides an interface between input and output devices, such as the display device 170 and the input device 180, and the peripheral interface 123.

The display unit 170 displays state information of the electronic device 100, characters input by a user, moving pictures, still pictures, etc. according to control of the graphic module 115. When the display unit 170 is equipped with a touch screen according to one exemplary embodiment of the present invention, the display unit 170 provides touch information of the touch screen to the processor module 120 through the I/O control module 160.

The input device 180 provides input data, generated by selection by the user, to the processor module 120 through the I/O control module 160. For one example, the input device 180 includes only a control button for controlling the electronic device 100. For another example, the input device 180 may be equipped with a keypad for receiving input data from the user.

The camera system 191 may connect to the optical sensor 192 and may perform a function for photographing objects and generating corresponding moving picture data and still picture data.

The motion sensor 193 and the optical sensor 192 may connect to the peripheral interface 123 and may perform several functions. For example, the motion sensor 193 and the optical sensor 192 may connect to the peripheral interface 123, may sense motion of the electronic device 100, and may sense light from outside of the electronic device 100. Furthermore, a position measurement system and other sensors such as a temperature sensor, a bio-sensor, etc. may connect to the peripheral interface 123 and may perform related functions.

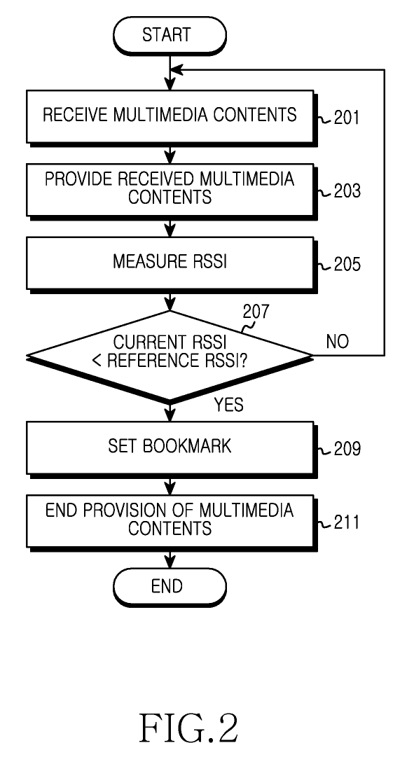

FIG. 2 is a flowchart illustrating a process of setting a bookmark for multimedia contents based on channel state information in the electronic device 100 according to the exemplary embodiment of the present invention.

Referring to FIG. 2, the electronic device 100 receives multimedia contents in step 201. For example, when the electronic device 100 requests transmission of multimedia contents provided from a network environment, the electronic device 100 receives the requested multimedia contents. Herein, the multimedia contents are multimedia writings such as digitized literary, music, photo, and art writings. The multimedia contents is defined herein as contents capable of being stored and used in an electronic device, such as the electronic device 100, or a series of information contents provided through a wireless Internet communication network or a high-speed data network.

The electronic device 100 proceeds to step 203 and provides the received multimedia contents to the user of the electronic device 100.

The electronic device 100 proceeds to step 205 and measures an RSSI thereof to verify channel state information of a network connected to the electronic device 100.

The electronic device 100 proceeds to step 207 and compares a current RSSI thereof with a reference RSSI, which may be stored, for example, in the data storing unit 111. For example, the electronic device 100 verifies whether the current RSSI is less than the reference RSSI. Herein, the reference RSSI used in the method of FIG. 2 is a criterion for determining whether the channel state of the network is unstable.

If the current RSSI of the electronic device 100 is greater than or equal to the reference RSSI in step 207, the electronic device 100 recognizes that the channel state of the network is stable. Therefore, the electronic device 100 returns to step 201 and continues to receive multimedia contents.

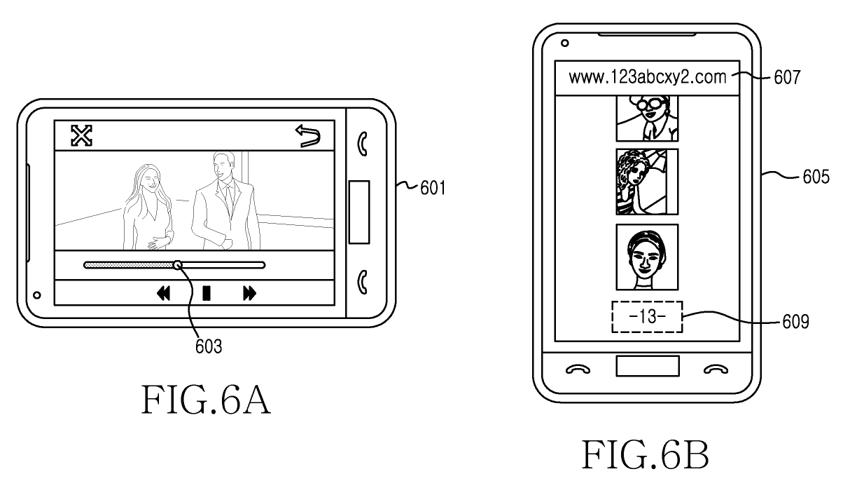

On the other hand, if the current RSSI of the electronic device 100 is less than the reference RSSI in step 207, the electronic device 100 recognizes that the channel state of the network is unstable. Therefore, the electronic device 100 proceeds to step 209 and sets a bookmark for the multimedia contents which are being provided. For one example, when the multimedia contents are video contents, as shown in FIG. 6A, an electronic device 601 sets a bookmark including a stop position 603 of the video contents and information about the video contents. For another example, when the multimedia contents are webtoon contents, as shown in FIG. 6B, an electronic device 605 sets a bookmark including a stop position 609 of the webtoon contents and information about the webtoon contents. Such set bookmarks, for example, such stop positions 603, 609, may be stored in the data storing unit 111.

The electronic device 100 proceeds to step 211 and ends the providing of the multimedia contents. For one example, when the multimedia contents are video contents, the electronic device 100 ends execution of a video player, which may be an application in the application module 118, the multimedia contents providing module 119, or other appropriate modules in the program storing unit 112. For another example, when the multimedia contents are webtoon contents, the electronic device 100 ends execution of a webtoon application, which may be an application in the application module 118, the multimedia contents providing module 119, or other appropriate modules in the program storing unit 112.

Thereafter, the electronic device 100 ends the method of FIG. 2.

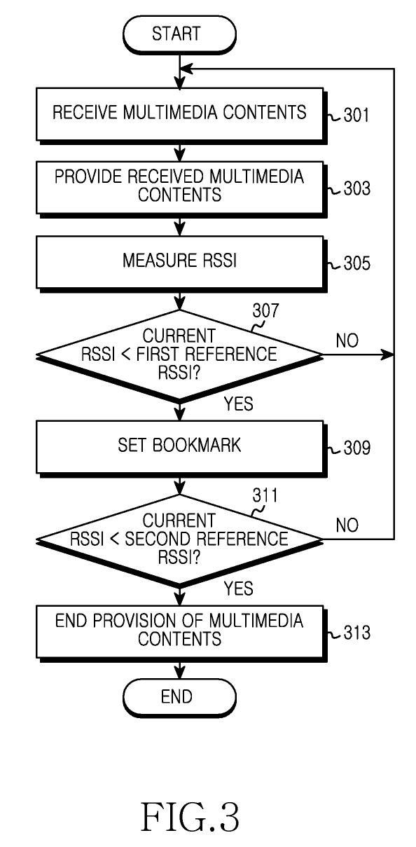

FIG. 3 is a flowchart illustrating a process of setting a bookmark for multimedia contents based on channel state information in the electronic device 100 according to an alternative exemplary embodiment of the present invention.

Referring to FIG. 3, the electronic device 100 receives multimedia contents in step 301. For example, when the electronic device 100 requests transmission of multimedia contents provided from a network environment, the electronic device 100 receives the requested multimedia contents.

The electronic device 100 proceeds to step 303 and provides the received multimedia contents to the user of the electronic device 100.

The electronic device 100 proceeds to step 305 and measures an RSSI thereof to verify channel state information of a network connected to the electronic device 100.

The electronic device 100 proceeds to step 307 and compares a current RSSI thereof with a first reference RSSI, which may be stored, for example, in the data storing unit 111. For example, the electronic device 100 verifies whether the current RSSI is less than the first reference RSSI. Herein, the first reference RSSI used in the method of FIG. 3 is a criterion for determining whether the channel state of the network is unstable.

If the current RSSI of the electronic device 100 is greater than or equal to the first reference RSSI in step 307, the electronic device 100 recognizes that the channel state of the network is stable. Therefore, the electronic device 100 returns to step 301 and continues to receive multimedia contents.

On the other hand, if the current RSSI of the electronic device 100 is less than the first reference RSSI in step 307, the electronic device 100 recognizes that the channel state of the network is unstable. Therefore, the electronic device 100 proceeds to step 309 and sets a bookmark for the multimedia contents which are being provided. For one example, when the multimedia contents are video contents, as shown in FIG. 6A, the electronic device 601 sets the bookmark including the stop position 603 of the video contents and the information about the video contents. For another example, when the multimedia contents are webtoon contents, as shown in FIG. 6B, the electronic device 605 sets the bookmark including the stop position 609 of the webtoon contents and the information about the webtoon contents. Such set bookmarks, for example, such stop positions 603, 609, may be stored in the data storing unit 111.

The electronic device 100 proceeds to step 311 and compares the current RSSI thereof with a second reference RSSI, which may be stored, for example, in the data storing unit 111, to verify the channel state information of the network. For example, the electronic device verifies whether the current RSSI is less than the second reference RSSI. Herein, the second reference RSSI used in the method of FIG. 3 is a criterion for determining that it is impossible, problematic, or difficult to provide or to reliably provide the multimedia contents from the network to the electronic device 100 based on the channel state information of the network with which the electronic device 100 is attempting to communicate.

If the current RSSI of the electronic device 100 is greater than or equal to the second reference RSSI, the electronic device 100 recognizes that it is possible to provide the multimedia contents based on the channel state information of the network. Therefore, the electronic device 100 returns to step 301 and continues to receive multimedia contents.

On the other hand, if the current RSSI of the electronic device 100 is less than the second reference RSSI, the electronic device 100 recognizes that it is impossible, problematic, or difficult to provide or to reliably provide the multimedia contents from the network to the electronic device 100 based on the channel state information of the network. Therefore, the electronic device 100 proceeds to step 313 and ends the providing of the multimedia contents. For one example, when the multimedia contents are video contents, the electronic device 100 ends execution of a video player. For another example, when the multimedia contents are webtoon contents, the electronic device 100 ends execution of a webtoon application.

Thereafter, the electronic device 100 ends the method of FIG. 3.

In accordance with the exemplary embodiments of the present invention, the above-described electronic device 100 sets the bookmark for multimedia contents based on the channel state information of the network. The set bookmark is then stored for later retrieval and for accessing the multimedia contents at the point where the bookmark was set.

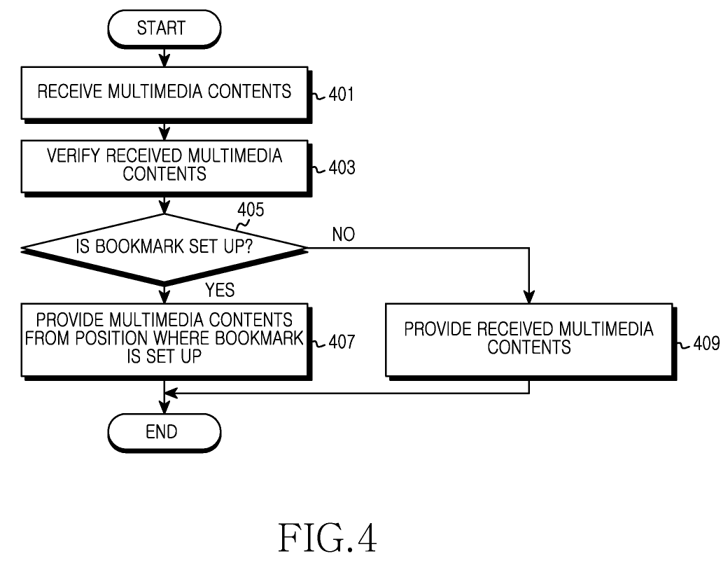

FIG. 4 is a flowchart illustrating a process of providing multimedia contents based on bookmark information in the electronic device 100 according to the exemplary embodiments of the present invention.

Referring to FIG. 4, the electronic device 100 receives multimedia contents in step 401. For example, when the electronic device 100 requests transmission of the multimedia contents provided from a network environment, the electronic device 100 receives the requested multimedia contents.

The electronic device 100 proceeds to step 403 and verifies the received multimedia contents.

The electronic device 100 proceeds to step 405 and verifies whether a bookmark for the received multimedia contents is set up. For example, the processor 122 of the electronic device 100 may search the data storing unit 111 for any bookmarks corresponding to the received multimedia contents.

If the bookmark for the received multimedia contents is not set up in step 405, the electronic device 100 proceeds to step 409 and provides the received multimedia contents from the start thereof and/or from the point in the multimedia contents at which the electronic device 100 receives the multimedia contents. For example, the multimedia contents may be a scheduled movie which starts at predetermined start times, and the electronic device 100 accesses the scheduled movie at a time later than the start time, and receives the scheduled movie at an intermediate point within the movie. The method in FIG. 4 then ends.

On the other hand, if the bookmark for the received multimedia contents is set up in step 405, the electronic device 100 proceeds to step 407 and provides the multimedia contents from a position where the bookmark was set up. At this time, the electronic device 100 transmits bookmark information to a server of the network to receive the multimedia contents from the position where the bookmark is set up. The electronic device 100 provides the multimedia contents received from the position where the bookmark is set up. When the bookmark information, including data corresponding to the position where the bookmark is set up, is received while the multimedia contents are received, the electronic device 100 provides the multimedia contents from the position in the multimedia contents where the bookmark is set up. For one example, when the multimedia contents are video contents, the electronic device 601, as shown in FIG. 6A, provides video contents from the position 603 where a bookmark is set up. For another example, when the multimedia contents are webtoon contents, the electronic device 605, as shown in FIG. 6B, provides webtoon contents from the position 605 where a bookmark is set up.

Thereafter, the electronic device 100 ends the method of FIG. 4.

In accordance with the exemplary embodiments of the present invention, the above-described electronic device 100 provides the multimedia contents based on bookmark information. That is, when the bookmark of the multimedia contents is set up, the electronic device 100 provides the multimedia contents from a position in the multimedia contents where the bookmark is set up.

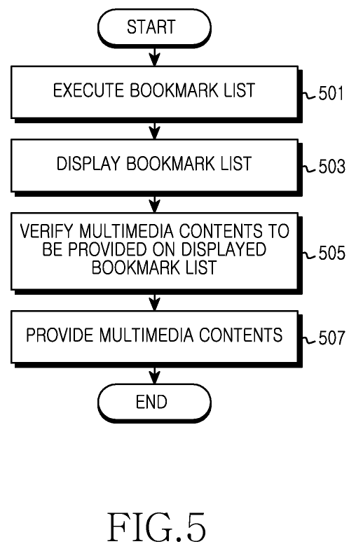

FIG. 5 is a flowchart illustrating a process of providing multimedia contents using a bookmark list in the electronic device 100 according to the exemplary embodiments of the present invention. The bookmark list is a collection of some or all bookmarks set in connection with multimedia contents, as described herein. The bookmark list may be stored in the data storing unit 111 in FIG. 1.

Referring to FIG. 5, the electronic device 100 executes a bookmark list for multimedia contents in step 501.

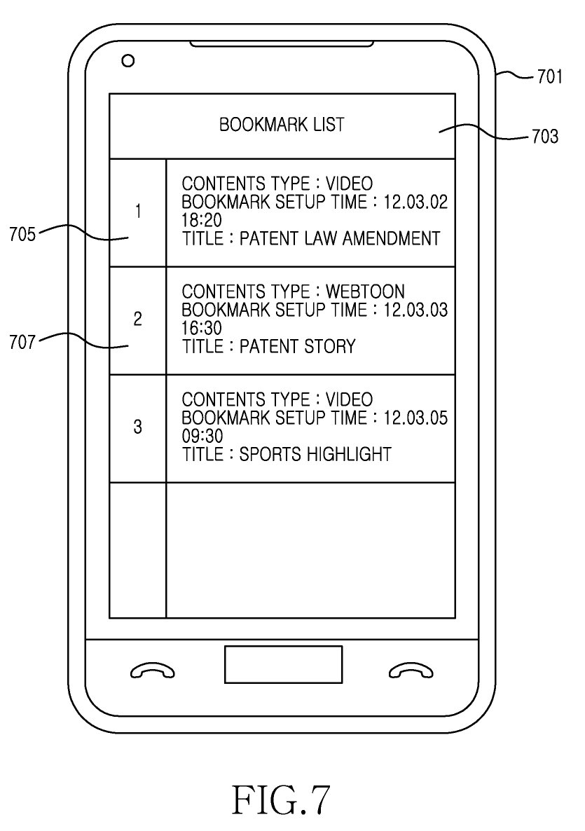

The electronic device 100 proceeds to step 503 and displays the bookmark list. For example, when the bookmark list for the multimedia contents is executed, the electronic device 100, shown in an exemplary embodiment as an electronic device 701, as shown in FIG. 7, displays a bookmark list 703 in a screen of a display unit. Herein, the bookmark list 703 includes at least one of a contents type, a bookmark setup time, and a title for each saved and/or set up bookmark.

The electronic device 701 proceeds to step 505 and verifies multimedia contents to be provided on the displayed bookmark list 703. For example, the electronic device 701, as shown in FIG. 7, verifies a bookmark selected on the bookmark list 703 by determining if the corresponding multimedia contents is available, for example, via a connection to a network or other service providers.

The electronic device 701 proceeds to step 507 and provides the selected multimedia contents. For one example, as shown in FIG. 7, when a first bookmark 705 is selected on the bookmark list 703, the electronic device 701 provides video contents, whose title is “patent law amendment”, in which a bookmark is set up at 18:20 on Mar. 2, 2012, according to information of the first bookmark 705. For another example, as shown in FIG. 7, when a second bookmark 707 is selected on the bookmark list 703, the electronic device 701 may provide webtoon contents, whose title is a “patent story”, in which the second bookmark is set up at 16:30 on Mar. 3, 2012, according to information of the second bookmark 707.

Thereafter, the electronic device 701 ends the method of FIG. 5.

In accordance with the exemplary embodiments of the present invention, the above-described electronic device 701 verifies multimedia contents to be provided through the bookmark list 703.

As described above, the electronic device 100, according to the exemplary embodiments of the present invention, has an advantage in that a user of the electronic device 100 may use multimedia contents which are compulsorily ended from a position within the multimedia contents, such as an interrupted, intermediate, and/or ended position, by providing a bookmark service for multimedia contents based on channel state information.

The above-described apparatus and methods according to the present invention can be implemented in hardware, firmware or as software or computer code that can be stored in a non-transitory recording medium such as a CD ROM, a RAM, a ROM, a floppy disk, DVDs, a hard disk, a magnetic storage media, an optical recording media, or a magneto-optical disk or computer code downloaded over a network originally stored on a remote recording medium, a computer readable recording medium, or a non-transitory machine readable medium and to be stored on a local recording medium, so that the methods described herein can be rendered in such software that is stored on the recording medium using a general purpose computer, a digital computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. In addition, the program may be electronically transferred through any media such as communication signals transmitted by wire/wireless connections, and their equivalents.

While the present invention has been particularly shown and described with reference to exemplary embodiments thereof, it will be understood by those skilled in the art that various changes in form and details may be made therein without departing from the spirit and scope of the present invention as defined by the appended claims

What is claimed is:

1. A method of providing a bookmark service in an electronic device, the method comprising:
receiving multimedia contents in the electronic device;
verifying channel state information of the electronic device; and
setting a bookmark associated with a position in the multimedia contents based on the channel state information of the electronic device.

2. The method of claim 1, wherein the multimedia contents are multimedia writings including at least one of digitized literary, music, photo, and art writings, and wherein the multimedia contents are at least one of contents which may be stored and used in the electronic device or a series of information contents provided through a wireless Internet communication network or a high-speed data network.

3. The method of claim 1, wherein the setting of the bookmark comprises setting the bookmark based on a Received Signal Strength Indicator (RSSI).

4. The method of claim 1, wherein the receiving of the multimedia contents in the electronic device comprises:
verifying whether any bookmark for the multimedia contents is set up; and
providing multimedia contents according to the verified bookmark.

5. The method of claim 4, wherein the providing of the multimedia contents comprises:
transmitting bookmark information corresponding to the set bookmark to a server; and
providing the multimedia contents received from the server and corresponding to the set bookmark.

6. The method of claim 4, wherein the providing of the multimedia contents comprises providing multimedia contents from a position in the multimedia contents where the bookmark is set up when the multimedia contents are received from a server.

7. A method of providing a bookmark service in an electronic device, the method comprising:
receiving multimedia contents in the electronic device;
verifying whether a bookmark for the multimedia contents is set up; and
providing multimedia contents according to the verified bookmark.

8. The method of claim 7, wherein the providing of the multimedia contents comprises:
transmitting bookmark information corresponding to the set up bookmark to a server; and
providing the multimedia contents received from the server and corresponding to the set up bookmark.

9. The method of claim 7, wherein the providing of the multimedia contents comprises providing multimedia contents from a position in the multimedia contents where the bookmark is set up when the multimedia contents are received from a server.

10. An electronic device comprising:
at least one processor;
a memory; and
at least one module, wherein each of the at least one module is stored in the memory and is configured to be executable by the at least one processor,
wherein each of the at least one module includes at least one instruction for receiving multimedia contents in the electronic device, verifying channel state information of the electronic device, and setting a bookmark associated with a position in the multimedia contents based on the channel state information of the electronic device.

11. The electronic device of claim 10, wherein the multimedia contents are multimedia writings including at least one of digitized literary, music, photo, and art writings, and wherein the multimedia contents are at least one of contents which may be stored and used in the electronic device or a series of information contents provided through a wireless Internet communication network or a high-speed data network.

12. The electronic device of claim 10, wherein the instructions for setting the bookmark include an instruction for setting the bookmark based on a Received Signal Strength Indicator (RSSI).

13. The electronic device of claim 10, further comprising at least one instruction for receiving multimedia contents in the electronic device, verifying whether any bookmark for the multimedia contents is set up, and providing multimedia contents according to the verified bookmark.

14. The electronic device of claim 13, wherein the instructions for providing the multimedia contents include an instruction for transmitting bookmark information corresponding to the set up bookmark to a server, and for providing multimedia contents received from the server and corresponding to the set bookmark.

15. The electronic device of claim 13, wherein the instructions for providing the multimedia contents include an instruction for providing multimedia contents from a position in the multimedia contents where the bookmark is set up when the multimedia contents are received from a server.

16. An electronic device comprising:
at least one processor;
a memory; and
at least one module, wherein each of the at least one module is stored in the memory and is configured to be executable by the at least one processor,
wherein each of the at least one module include at least one instruction for receiving multimedia contents in the electronic device, verifying whether a bookmark for the multimedia contents is set up, and providing multimedia contents according to the verified bookmark.

17. The electronic device of claim 16, wherein the instructions for providing the multimedia contents include an instruction for transmitting bookmark information corresponding to the set up bookmark to a server, and for providing the multimedia contents received from the server and corresponding to the set bookmark.

18. The electronic device of claim 16, wherein the instructions for providing the multimedia contents include an instruction for providing multimedia contents from a position in the multimedia contents where the bookmark is set up when the multimedia contents are received from a server.
